(19) United States
(12) Patent Application Publication
(10) Pub. No.: US 2007/0070870 A1
(43) Pub. Date: Mar. 29, 2007

(54) Servo pattern having reduced noise due to speed variations in linear data storage media

(75) Inventor: Stephen J. Rothermel, Roseville, MN (US)

Correspondence Address: Attention: Eric D. Levinson;Imation Corp., Legal Affairs, P.O. Box 64898, St. Paul, MN, 55164-0898, US

(73) Assignee: Imation Corp.

(21) Appl. No.: 11/239,583

(22) Filed: Sep. 28, 2005

(51) Int. Cl. G11B 7/24

(52) U.S. Cl. 369/275.2; 369/275.3

(57) ABSTRACT

A set of servo patterns on two or more servo tracks, at least one of which is adjacent to a data track, is described. One or more servo patterns in the set are inverted copies of one or more upright servo patterns in a different servo track. Using this set of servo patterns to calculate a position error signal (PES) for a servo head reduces error in PES calculations due to variations in media velocity.

### TECHNICAL FIELD

The invention relates to data storage media and, more particularly, to linear data storage media including servo patterns.

### BACKGROUND

Data storage media are commonly used for storage and retrieval of data and come in many forms, such as magnetic tape, magnetic disks, optical tape, optical disks, holographic disks or cards, and the like. In magnetic media, data is typically stored as magnetic signals that are magnetically recorded on the medium surface. For linear data storage media, such as tape, the data stored on the medium is typically organized along “data tracks.” A typical linear magnetic storage medium, such as magnetic tape, usually includes several data tracks and one or more servo tracks typically located between sets of data tracks. Optical media, holographic media and other media formats can also make use of data tracks.

Servo patterns refer to signals or other recorded marks within the servo tracks that are used for tracking purposes. A servo controller interprets detected servo patterns and generates position error signals. A position error signal (PES) is used to adjust the lateral distance of the read/write head relative to the data tracks so that the read/write head is properly positioned along the data tracks for effective reading and/or writing of the data to the data tracks. A plurality of data tracks may be defined relative to one or more servo tracks. Most magnetic media include a plurality of servo tracks, with data tracks being located between the servo tracks.

Time-based servo techniques refer to servo techniques that make use of time variables. Time-based servo techniques are particularly effective for magnetic tape, which typically feeds past servo heads at a constant velocity. Servo markings have taken a variety of forms, e.g., “//// \\\\,” chevron-shaped patterns like “<<<< >>>>”, N-shaped patterns like “///\\\///”, and others.

When time-based servo techniques are used, the time offset between the detection of two or more servo marks can be translated into a PES, which defines a lateral distance of the servo head relative to a data track. For example, given a constant velocity of linear data storage media formed with servo pattern “/ ∴”, the time between detection of mark “/” and mark “\” becomes longer when the servo head is positioned towards the bottom of pattern “/ \” and shorter if the servo head is positioned towards the top of pattern “/ \”. Given a constant velocity of linear data storage media, a defined time period between detected servo signals may correspond to a center of pattern “/ \”. By locating the center of pattern “/ \”, a known distance between the center of the servo track and the data tracks can be identified. Time-based servo patterns are also commonly implemented in magnetic tape media, but may be useful in other media.

Increasing linear data storage media velocity reduces data writing and data access times. However, increasing magnetic tape velocity can result in a greater variation of tape velocity. Variances in tape velocity can be very disruptive to time-based servo techniques because tape velocity is used in conjunction with the time offset between the detection of two or more servo marks to calculate a PES. Reducing the sensitivity of PES calculations to tape velocity variation can allow for an increase in the accuracy of PESs.

### SUMMARY

In general, the invention is directed to servo techniques that make use of a set of servo patterns. The set includes at least one servo frame having an N-shaped configuration and at least one corresponding substantially inverted copy of the frame having an inverted N-shape. The inverted copy may be coincident with the upright servo pattern on a separate servo track. This configuration allows cancellation of error in PES calculations due to fluctuations in linear data storage media velocity.

In one embodiment, a linear data recording medium comprises a first servo track extending along the length of the medium, a second servo track extending along the length of the medium, a first time-based servo pattern within the first servo track, wherein the first time-based servo pattern includes a first servo mark, a second servo mark, and a third servo mark, wherein the third servo mark is non-parallel to the first and second servo marks and a second time-based servo pattern within the second servo track, wherein the second time-based servo pattern comprises a substantially inverted copy of the first time-based servo pattern, wherein a copy of the first servo mark, a copy of the second servo mark and a copy of the third servo mark included in the second time-based servo pattern are substantially inverted with respect to the length of the medium as compared to the first, second and third servo marks.

In another embodiment, a method comprises sensing a first time-based servo pattern on a recording medium moving in a first direction with a first head of a servo read module, wherein the first time-based servo pattern includes a first servo mark, a second servo mark, and a third servo mark, wherein the third servo mark is non-parallel to the first and second servo marks, sensing a second time-based servo pattern on the recording medium with a second head of the servo read module, wherein the second time-based servo pattern comprises a substantially inverted copy of the first time-based servo pattern, wherein a copy of the first servo mark, a copy of the second servo mark and a copy of the third servo mark included in the second time-based servo pattern are substantially inverted with respect to the first direction as compared to the first, second and third servo marks, calculating a position error signal as a function of the sensed time-based servo patterns and adjusting positioning of the servo write or read module based on the calculated position error signal.

In one embodiment, a head for recording a time-based servo pattern comprises a first set of servo write gaps that correspond to a first servo frame to be recorded in a first servo track including a first gap, a second gap, and a third gap, wherein the third gap is non-parallel to the first and second gaps and a second set of servo write gaps that correspond to a second servo frame to be recorded in a second servo track, wherein the second set of servo write gaps includes a substantially inverted copy of the first set of servo write gaps, wherein a copy of the first gap, a copy of the second gap and a copy of the third gap included in the second set of servo write gaps are inverted with respect to the length of the servo tracks as compared to the first, second and third gaps.

In a different embodiment, a linear data recording medium comprises a first data track extending along a length of the medium, a second data track extending along the length of the medium, a first time-based servo pattern within the first data track, wherein the first time-based servo pattern includes a first servo mark, a second servo mark, and a third servo mark, wherein the third servo mark is non-parallel to the first and second servo marks and a second time-based servo pattern within the second data track, wherein the second time-based servo pattern comprises an inverted copy of the first time-based servo pattern, wherein a copy of the first servo mark, a copy of the second servo mark and a copy of the third servo mark included in the second time-based servo pattern are inverted with respect to the length of the medium as compared to the first, second and third servo marks.

Various aspects of the invention can provide a number of advantages. For example, the combination of an N-shaped servo pattern and a coincident substantially inverted copy of the N-shaped servo pattern produces strong error cancellation in PES calculations for error due to fluctuations in media velocity at all frequencies of media velocity fluctuation. Furthermore, detection of the marks of a single frame of the N-shaped servo pattern can, by itself, allow for PES generation, unlike some patterns, such as “/// \\\,” which require the detection of successive frames for PES generation. This may improve data density for digital data storage media. Moreover, the invention does not necessarily require use of dedicated servo tracks. Instead, for example, the described servo patterns may be placed in dedicated sectors of data tracks, which can be read simultaneously.

The details of one or more embodiments of the invention are set forth in the accompanying drawings and the description below. Other features, objects, and advantages of the invention will be apparent from the description and drawings, and from the claims.

### BRIEF DESCRIPTION OF DRAWINGS

FIG. 1 is an illustration of a portion of a linear data storage media including repeating N-shaped servo patterns in a first servo track and repeating substantially inverted N-shaped servo patterns in a second servo track.

FIG. 2 is an illustration of a linear data storage media including repeating N-shaped servo patterns in a first servo track and repeating substantially inverted N-shaped servo patterns in a second servo track.

FIG. 3 is a graph showing error in a PES calculation derived from an N-shaped servo pattern.

FIG. 4 is a graph showing error in a PES calculation derived from a pair of servo patterns including an N-shaped servo pattern and a substantially inverted N-shaped servo pattern.

FIG. 5 is a block diagram of an exemplary servo writing system for pre-recording servo patterns on magnetic tape.

FIG. 6A is a top view illustration of an exemplary servo head module comprising a first head and a second head separated by a conductive or magnetically permeable shield.

FIG. 6B is a side view illustration of the exemplary servo head module illustrated in FIG. 6A.

FIG. 7 is a flow diagram of a time-based method for calculating a PES.

FIG. 8 is an illustration of a linear data storage media including repeating N-shaped servo patterns embedded within data tracks of the linear storage media.

### DETAILED DESCRIPTION

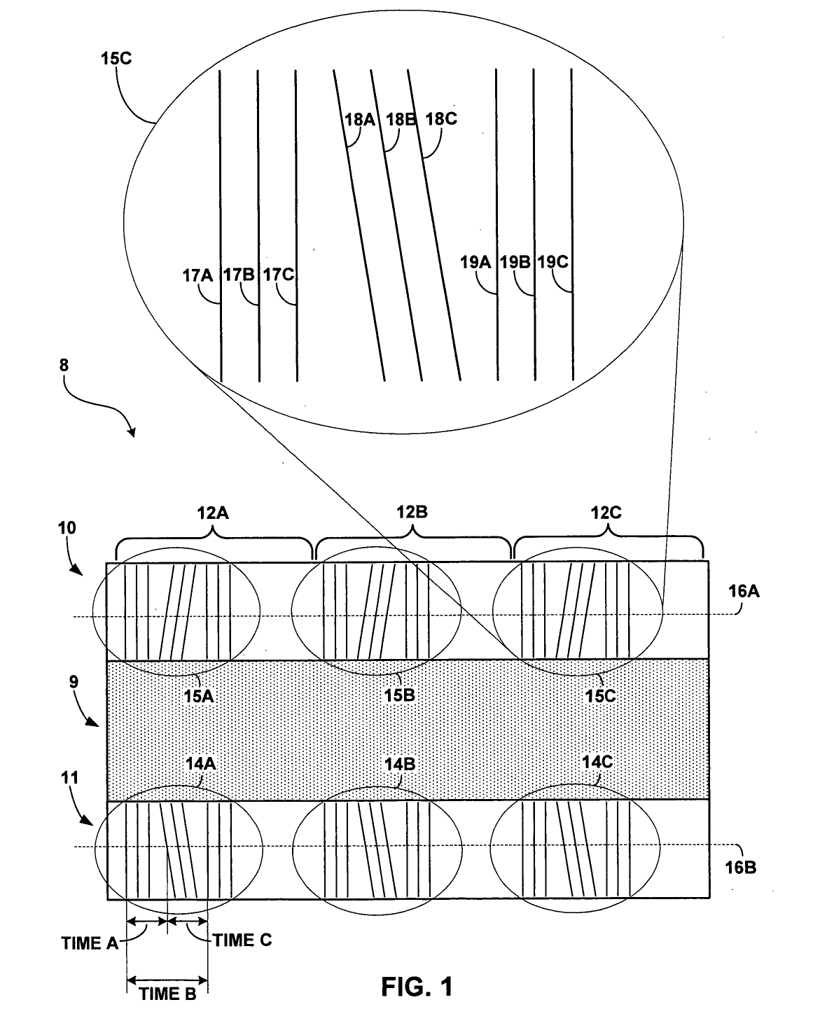

FIG. 1 is a conceptual view illustrating magnetic tape media 8 including data tracks 9, servo track 10 and servo track 11. Servo track 10 includes servo frames 12A-12C (“frames 12”). Frames 12 include N-shaped servo patterns 15A-15C (“patterns 15”). Servo track 11 also includes three servo frames, each including one of substantially inverted N-shaped servo patterns 14A-14C (“patterns 14”). For illustration proposes, FIG. 1 also includes an exploded close-up view of servo pattern 15C. Time-based servo techniques facilitate positioning of servo head relative to data tracks 9. The time-based servo techniques make use of individual markings within patterns 14 and 15, as illustrated in FIG. 1 with respect to pattern 14A. Data tracks 9 reside a known distance from servo tracks 10 and 11. Thus, by locating a position of servo head paths 16A and 16B (“paths 16”) relative to servo tracks 10 and 11, a PES can be generated to identify lateral positioning error of the servo head relative to the data track(s).

Each of servo patterns 15 is substantially similar; additionally, servo patterns 14 are substantially similar to servo patterns 15, with the exception that servo patterns 14 are substantially inverted relative to servo tracks 10 and 11. The following discussion describes servo pattern 15C, but is applicable to all of servo patterns 14 and 15. Servo pattern 15C includes a first servo line 17A, a second servo line 19A and a third servo line 18A. First servo line 17A and second servo line 19A are substantially straight lines and are parallel to each other. Third servo line 18A is straight but non-parallel to first servo line 17A. Third servo line 18A is disposed between first servo line 17A and second servo line 19A, creating an N-shaped pattern. This N-shaped pattern is produced a second time with lines 17B, 18B and 19B and a third time with lines 17C, 18C and 19C.

As shown in FIG. 1, servo pattern 15C comprises three servo line sets 17, 18 and 19. Servo line set 17 comprises three parallel servo lines, 17A-17C. Similarly, servo line set 19 comprises three parallel servo lines, including second servo lines 19A-19C, and servo line set 18 comprises three servo lines, including servo lines 18A-18C. Servo line sets 17 and 19 are parallel to each other. Consequently, the distance between servo line sets 17 and 19 is constant for any servo head paths 16 position.

Servo line set 18, disposed between servo line sets 17 and 19, is not parallel to servo line sets 17 and 19. Rather, servo line set 18 is angled between servo line sets 17 and 19. Consequently, the distance between servo line set 17 and servo line set 18 (time A) is not constant for any servo head path 16 position, and the distance between servo line set 19 and servo line set 18 (time C) is not constant for any servo head path 16 position. However, distance between servo line set 17 and servo line set 19 (time B) is constant for any servo head path 16 position.

Servo line sets 17, 18 and 19 each include three separate servo lines. A time-based servo pattern may include multiple servo marks to improve the quality of the signal that results when the pattern is sensed. In theory, pattern 15C could function with single servo lines 17A, 18A and 19A. Patterns 15C may be adapted to servo line sets having any number of servo lines.

Servo patterns 14 and 15 offer numerous advantages. First, servo patterns 14 and 15 are each self-contained and unambiguous, e.g., the time between an encounter with servo line set 17 and an encounter with servo line set 18, when compared with the time between an encounter with servo line set 17 and an encounter with servo line set 19, is determinative of the lateral position of the servo head. Servo patterns 14 and 15 are self-contained because the lateral position of the servo head can be determined by the time-based ratio using time measurements from a single servo pattern.

Another advantage of servo patterns 14 and 15 is the time-based ratio described above is proportional to the lateral position of the servo head without regard to the speed of the medium relative to the servo head. As a result, the ratio of time B to time C or to time A, as illustrated on servo pattern 14A, can be used to normalize PES calculation for tape speeds that remain consistent for the time it takes to measure time B. However, fluctuations in tape speed can occur. Fluctuations in tape speed cause the average tape speed over the time it takes to measure time B to be different from the average tape speed over the time it take to measure time A. Therefore, time B may not accurately normalize time A in the presence of tape speed fluctuations.

However, error due to tape speed fluctuations may be reduced if a PES signal is calculated using at least one of servo patterns 14 in conjunction with at least one of servo patterns 15. This effect is maximized if a servo pattern 15 on servo track 10 is used with a coincident servo pattern 14 on servo track 11, e.g., servo pattern 15A with servo pattern 14A. Because servo patterns 14 are substantially inverted within servo track 11 relative to servo patterns 15 in servo track 10, the error due to high-frequency tape speed fluctuations in PES calculations from servo track 10 is approximately opposite to error due to high-frequency tape speed fluctuations in PES calculations from servo track 11. By combining measurements from both servo tracks 10 and 11, the calculated error in a PES calculation can be reduced. By using servo patterns 14 with servo patterns 15, the advantages inherent to N-shaped servo patterns are maintained. In addition, the effect of tape speed fluctuations on PES calculations is reduced.

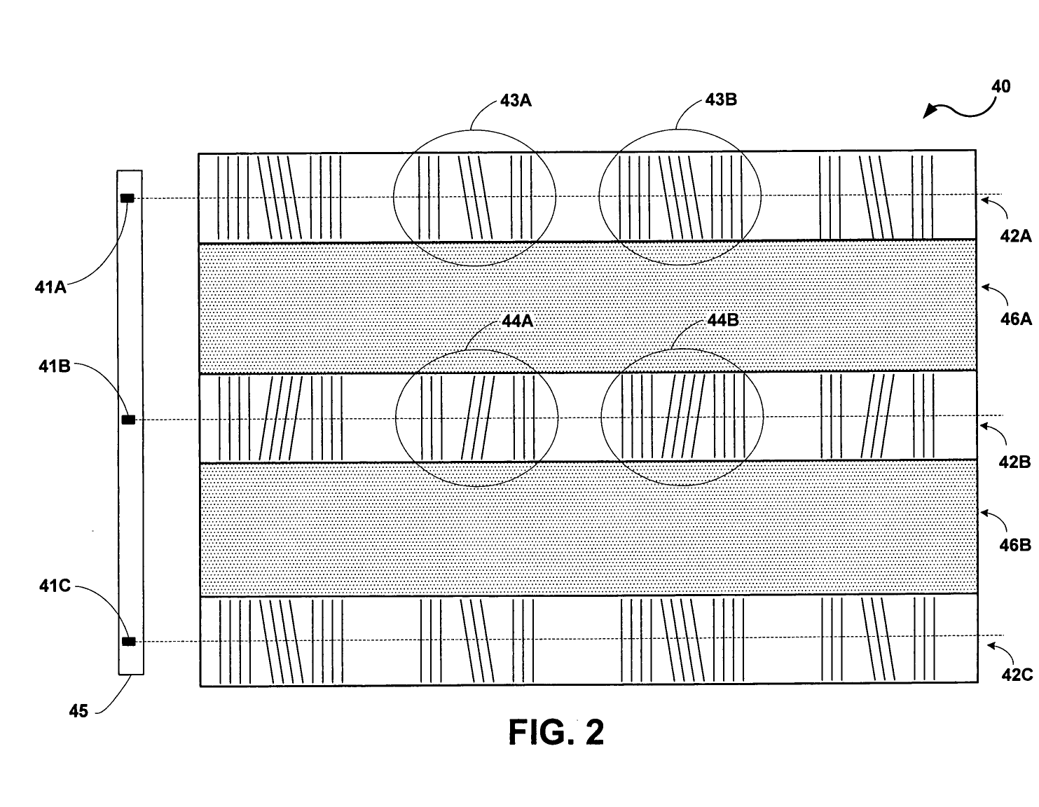

FIG. 2 shows servo read module 45 including three heads 41A-41C (“heads 41”) positioned adjacent to magnetic tape 40. Magnetic tape 40 includes servo tracks 42A-42C (“servo tracks 42”) and data tracks 46A and 46B (“data tracks 46”), which are positioned relative to servo tracks 42. Servo tracks 42 each include four servo patterns. More specifically, servo tracks 42A and 42C includes servo patterns 43A and 43B (“servo patterns 43”) and servo track 42B includes substantially inverted servo patterns 44A and 44B (“servo patterns 44”). As heads 41 pass over servo tracks 42, heads 41 receive signals from servo marks within servo patterns 43 and substantially inverted servo patterns 44. From these signals, the position of heads 41 can be calculated. Servo read module 45 may also contain additional heads (not shown) to read and/or write data to data tracks 46. Using the fixed position of heads 41 on servo read module 45, the location of these additional heads relative to data tracks 46 may be determined.

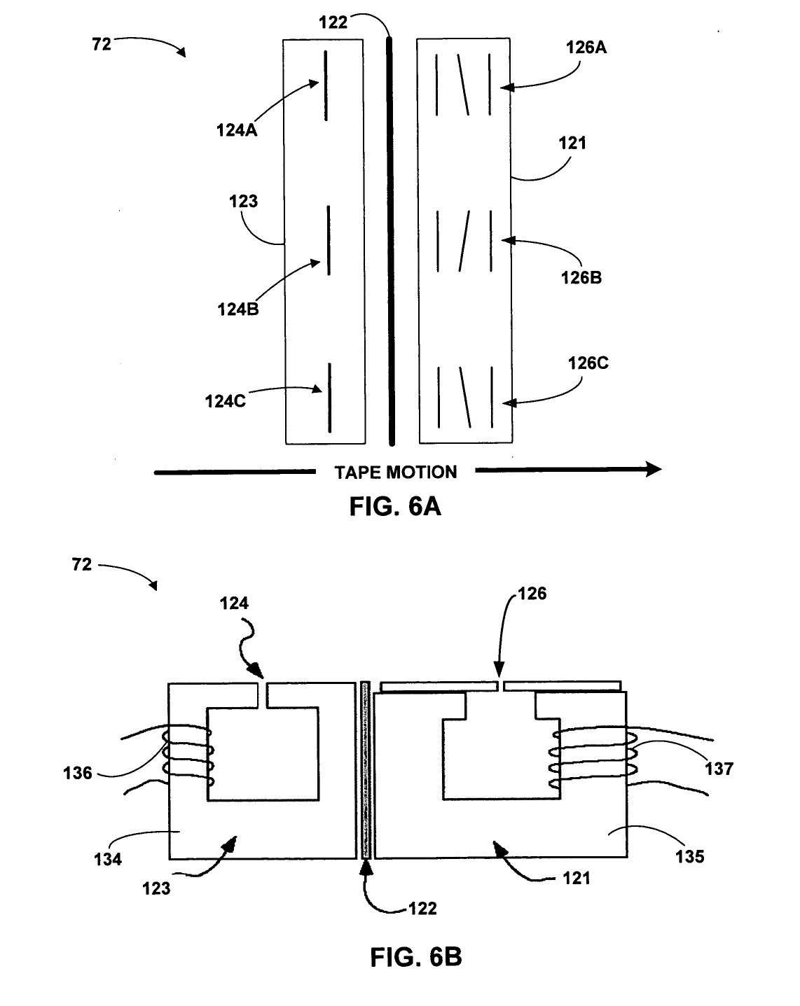

Servo patterns 43A and 43B may each be written using the same servo write head. A servo write head may use three electrical pulses to create pattern 43A and four electrical pulses to create pattern 43B. Likewise, servo patterns 44A and 44B may also be written using the same servo write head. One reason for varying the number of marks within servo patterns is to encode linear positioning information within servo tracks 42. Moreover, the distance between servo patterns in servo tracks 42 could be varied to encode linear positioning information within servo tracks 42. By encoding linear positioning information within servo tracks 42, the linear position of magnetic tape 40 can be determined. In magnetic tape 40, coincident servo patterns each have the same number of marks. Therefore, the servo patterns on each of servo tracks 42 may have been written by a single servo write head, e.g., servo head 72 as shown in FIG. 6A. In other embodiments, the number of servo marks for coincident servo patterns may vary. Such embodiments may require using multiple servo heads to create the coincident servo patterns.

Substantially inverted servo pattern 44A is a mirror image of servo pattern 43A, and substantially inverted servo pattern 44B is a mirror image of servo pattern 43B. Each substantially inverted servo patterns 43 in servo track 42B is coincident with two servo patterns 43, one in each of servo tracks 42A and 42C. Coincident servo patterns are those which are read by separate heads 41 at the same time. A group of coincident servo patterns may be used in a single PES calculation because heads 41 are fixed relative to one another on servo read module 45. Therefore, position error of each of heads 41 is the same. However, separate PES calculations from each of heads 41 may produce different results.

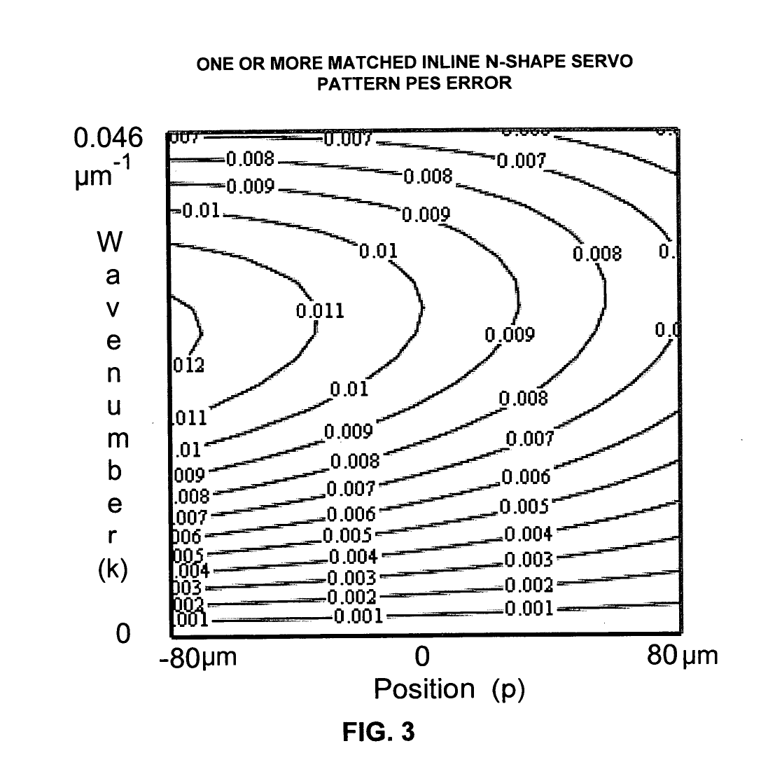

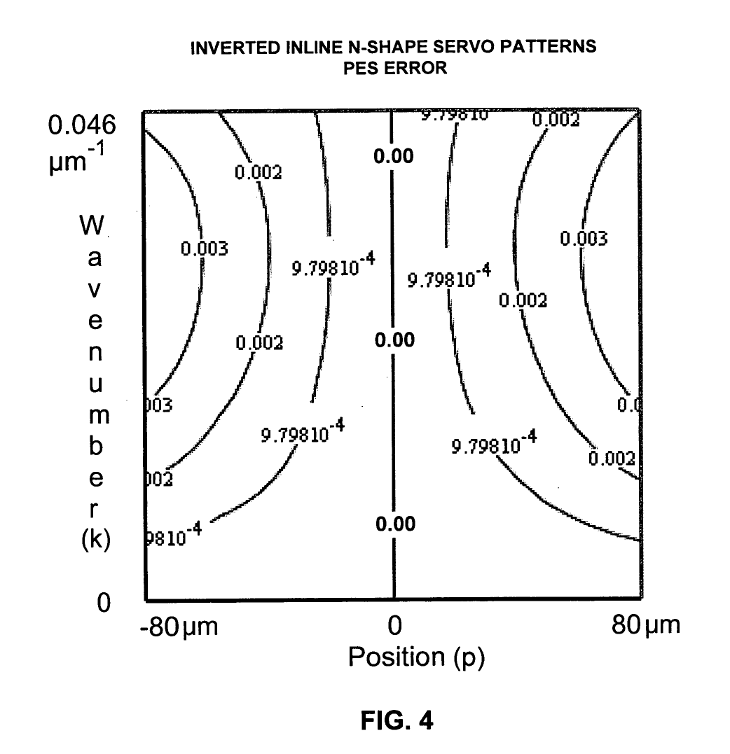

For example, in the event of tape velocity fluctuations, the error due to the tape velocity fluctuations in a PES calculated using timing measured by head 41A is different from the error due to the tape velocity fluctuations in a PES calculated using timing measured by head 41B. In fact, as will be described in greater detail with respect to FIGS. 3 and 4, the error in a PES calculated using timing measured by head 41A is approximately the opposite of the error calculated using timing measured by head 41B. In this manner, a combined PES calculation, using measured times from servo track 42B and at least one of servo tracks 42A and 42C, can reduce the effect of tape velocity fluctuation on PES calculation for servo read module 45.

In contrast, the effect of tape velocity fluctuation on PES calculation error using servo track 42A and another servo track with the same servo pattern rather than an inverse servo pattern, e.g., servo track 42C, is the same. A magnetic tape having only matched servo marks read at the same time does not allow for cancellation of velocity fluctuations. If servo patterns are identical and coincident, then the error due to tape velocity fluctuation is the same for both patterns. The information is from each pattern is the same and there is no way to cancel out acceleration error. Therefore, measurements only from servo track 42A and 42C cannot be used to not reduce the error in PES calculations due to tape velocity fluctuation in tape 40. With magnetic tape 40, measurements from substantially inverted servo patterns 44 and at least one coincident servo pattern 43 are used to cancel due to media velocity fluctuations.

Servo patterns 43 and substantially inverted servo patterns 44 each produce a PES response in the same direction from time responses in opposite directions when the position of servo read module 45 is changed. They also each produce a PES response in opposite directions from time responses in the same direction when the acceleration occurs over a measured time interval. Because substantially inverted servo patterns 44 may be measured at the same time as servo patterns 43 with the servo read heads 41 positioned “on-center” so that both servo read elements receive a signal from the servo stripes at the same time, then any measurement error produced by acceleration is canceled out when servo read module 45 position is calculated. If servo read heads 41 are positioned “off-center” of servo patterns 43, then measurement error is partially canceled out. Calculated errors in PES calculations for matched coincident servo patterns and inverted coincident servo patterns are shown in FIGS. 3 and 4, respectively.

FIG. 3 is a graph showing error in a PES calculation derived from repeating N-shaped servo pattern. As explained with respect to FIG. 2, PES calculation error due to velocity fluctuations will be the same for any number of matched coincident servo patterns. Therefore, FIG. 3 is applicable to any number of one or more matched coincident N-shaped servo patterns.

An N-shaped servo pattern, e.g., a pattern including marks 17A, 18A and 19A, was used in order to explicitly calculate the acceleration error shown in FIG. 3. For this equation, the slope of marks 17A and 19A were set to be opposite in sign to the slope of mark 18A. The error magnitude due to velocity fluctuations for any number of one or more matched coincident servo patterns was calculated for displacement due to sinusoidal media velocity fluctuations using equation 1.

$$h ( a , b , d , j , k , p , x ) \text{:} = \frac{j \cdot sin [ k \cdot ( x + a - p \cdot d ) ] - j \cdot sin [ k \cdot ( x + p \cdot d ) ]}{b + j \cdot sin [ k \cdot ( x + a - p \cdot d ) ] - j \cdot sin [ k \cdot ( x + p \cdot d ) ]} \qquad ( Equation 1 )$$

The variables for this equation are a, b, d, j, k, p, and x. In reference to FIG. 1, “a” is the actual distance between marks 17A and 18A at the “center” of the pattern, “b” is the actual distance between marks 17A and 19A, “d” is the reciprocal of the slope of mark 18A, “−d” is the reciprocal of the slopes of marks 17A and 19A, “j” is the magnitude of the displacement caused by the acceleration, “k” is the wavenumber defining the frequency of the change in tape velocity (k=2*π/λ), “p” is the position of the servo read element relative to the “center” of the pattern, and “x” is the displacement of the tape, including any displacement due to acceleration error.

FIG. 3 shows the PES calculation error, “h” is μm calculated after plugging the following values into equation 1:

a=50 μm

b=100 μm

d=15/150

j=1 μm

0<k<0.048 μm⁻¹

−80 μm<p<80 μm

Equation 1 was graphed by selecting 21 wavenumbers and 21 positions. Then, for each wavenumber and position, the maximum magnitude of the equation was determined as x was varied from zero to the wavelength. Then the maximum magnitudes were used to generate a contour plot.

As shown in FIG. 3, the error in a PES calculation using one or more coincident N-shaped servo patterns is on the order of 0.01 μm per 1 μm of displacement error and maximizes when k is equal to about 0.03 μm⁻¹. As k becomes less than about 0.03 μm⁻¹, i.e., as the frequency of the change in tape velocity is reduced, the error in a PES calculation becomes smaller because of the N-shaped pattern's ability to cancel out low-frequency variations in tape velocity. As k becomes greater than 0.03 μm⁻¹, but less than 0.06 μm⁻¹, i.e., as the frequency of the change in tape velocity increases toward a null, the error in a PES calculation becomes smaller because the sinusoidal changes in tape velocity over distance “a” and distance “b” result in the average tape velocity over distance “a” being nearly equal to the average tape velocity over distance “b”. More succinctly, at 0 μm⁻¹, 0.06 μm⁻¹, and other nulls, the average tape velocity over distance “a” is at or near the average tape velocity over distance “b”, but at 0.03 μm⁻¹, 0.09 μm⁻¹ and other maxima, the average tape velocity over distance “a” differs the most from the average tape velocity over distance “b”.

FIG. 4 is a graph showing error in a PES calculation derived from a pair of servo patterns including an N-shaped servo pattern and a substantially inverted N-shaped servo pattern. As described previously, cancellation of the error in a PES calculation can be achieved using at least one servo pattern and at least one substantially inverted servo pattern corresponding to the at least one servo pattern. In most situations, the substantially inverted servo pattern should be coincident with the at least one servo pattern to produce the most effective cancellation effect.

By using two or more coincident servo patterns, error in PES calculations due to high-frequency fluctuation in tape velocity can be reduced. This effect is illustrated in FIG. 4, a graph created according to equation 2. Equation 2 is the error in a PES calculation for a set of coincident N-shaped servo patterns, including at least one upright N-shaped servo pattern and one coincident inverted N-shaped servo pattern. As in equation 2, the slope of marks 17A and 19A are opposite in sign to the slope of mark 18A.

$$i ( a , b , d , j , k , p , x ) \text{:} = 0.5 \cdot [ \begin{matrix}\frac{\begin{matrix}j \cdot sin [ k \cdot ( x + a - p \cdot d ) ] - \\ j \cdot sin [ k \cdot ( x + p \cdot d ) ]\end{matrix}}{\begin{matrix}b + j \cdot sin [ k \cdot ( x + b - p \cdot d ) ] - \\ j \cdot sin ( k \cdot x + p \cdot d )\end{matrix}} … + \\ \frac{\begin{matrix}j \cdot sin [ k \cdot ( x + a + p \cdot d ) ] - \\ j \cdot sin [ k \cdot ( x - p \cdot d ) ]\end{matrix}}{\begin{matrix}b + j \cdot sin [ k \cdot ( x + b - p \cdot d ) ] - \\ j \cdot sin [ k \cdot ( x - p \cdot d ) ]\end{matrix}}\end{matrix} ] \qquad ( Equation 2 )$$

The variables in equation 2 are the same as in equation 1. Again with reference to FIG. 1, “a” is the actual distance between marks 17A and 18A at the “center” of the pattern, “b” is the actual distance between marks 17A and 19A, “d” is the reciprocal of the slope of mark 18A, “−d” is the reciprocal of the slope of marks 17A and 19A, “j” is the magnitude of the displacement caused by the acceleration, “k” is the wavenumber defining the frequency of the change in tape velocity (k=2*π/λ), “p” is the position of the servo read element relative to the “center” of the pattern, and “x” is the displacement of the tape, including any displacement due to acceleration error.

FIG. 4 shows the PES calculation error, “i” in μm calculated after plugging the same values into equation 2 as were used for equation 1 to produce FIG. 3:

a=50 μm

b=100 μm

d=15/150

j=1 μm

0<k<<0.048 μm⁻¹

−80 μm<p<80 μm

As with calculations for FIG. 3, equation 2 was graphed by selecting 21 wavenumbers, and 21 positions. Then, for each wavenumber and position, the maximum magnitude of the equation was determined as x was varied from zero to the wavelength. Then the maximum magnitudes were used to generate a contour plot.

As seen in FIG. 4, when y=0, i=0. That is, a set of servo patterns including an upright N-shape pattern and a coincident substantially inverted N-shape pattern may be used to exactly cancel out error in a PES calculation when servo heads are exactly on center. The PES calculation error cancellation effect is reduced as the servo heads are displaced from the on-center position. However, the maximum PES calculation error shown in FIG. 4 (0.003 μm) is only one-quarter of the maximum PES calculation error in FIG. 3 (0.012 μm). Furthermore, for any combination of frequency and servo head position the PES calculation error is less in FIG. 4 than in FIG. 3.

The result shown in FIG. 4 is similar to the result in FIG. 3 in that for all y≠0, the error in a PES calculation maximizes when k is equal to about 0.03 μm⁻¹. Just like the result using one or more matched coincident N-shaped servo pattern, as shown in FIG. 3, as k becomes greater than 0.03 μm⁻¹, the error in a PES calculation becomes smaller. Also, as k becomes less than 0.03 μm⁻¹, the error in a PES calculation becomes smaller. In this manner, the PES calculation error cancellation advantages of the N-shaped servo pattern are preserved by PES calculation techniques utilizing two or more coincident N-shaped patterns including at least one substantially inverted pattern. By including at least one coincident substantially inverted N-shaped pattern with an upright N-shaped pattern, PES calculation error is reduced at all frequencies and servo head positions as compared to using one or more matched servo patterns.

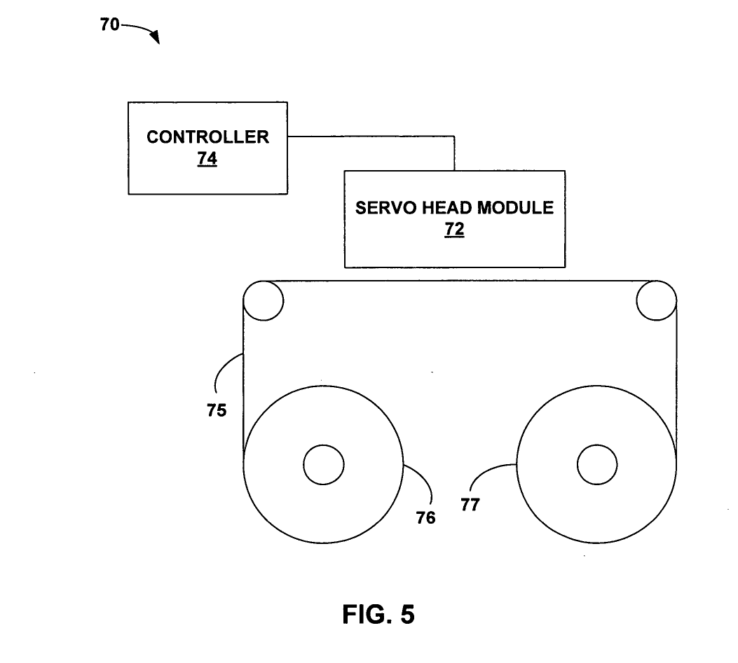

FIG. 5 is a block diagram illustrating an exemplary servo writing system 70 for pre-recording servo patterns on magnetic tape 75. For example, system 70 may be used to pre-record servo patterns similar to servo patterns 43 and 44 in FIG. 2. System 70 includes servo head module 72, servo controller 74, and magnetic tape 75 spooled on spools 76 and 77. Servo head module 72 may contain two servo heads, including a servo track write head and a servo write head as shown in FIGS. 6A and 6B, or a single servo write head. Controller 74 controls the magnetic fields applied by the one or more servo heads of servo head module 72. Magnetic tape 75 feeds from spool 76 to spool 77, passing in close proximity to servo head module 72. For example, magnetic tape 75 may contact the one or more servo heads of servo head module 72 during servo recording.

Servo head module 72 comprises electromagnetic elements that generate magnetic fields. In one embodiment, controller 74 may cause a first servo head to write substantially over the entirety of each servo track associated with magnetic tape 75. Then controller 74 can cause at least one additional servo head within servo head module 72 to selectively write servo marks forming servo patterns within prerecorded servo tracks.

In a different embodiment, the servo track portion of magnetic tape 75 may be randomly magnetized. Controller 74 may cause at least one servo head within servo head module 72 to write servo marks within randomly magnetized servo tracks. Predetermined distances between the servo marks may be unique for each servo track. Also, the distances between servo frames may also be varied. In these ways, the servo pattern may allow for inherent servo track identification and also for encoding linear position information.

FIG. 6A is a top view of exemplary servo head module 72 from FIG. 5 comprising a first head 123 and a second head 121 separated by a conductive or magnetically permeable shield 122. FIG. 6B is a side view of servo head 72. First head 123 and second head 121 are configured to record a plurality of servo frames within three servo tracks on a magnetic tape. In particular, heads 123 and 121 may be used to create a plurality servo frames similar to servo patterns 43 and 44 in FIG. 4.

First head 123 and second head 121 include ferromagnetic cores 134 and 135 respectively. Cores 134 and 135 are typically constructed of two or three pieces of ferromagnetic material. First head 123 includes write gaps 124A-C (“write gaps 124)”. Second head 121 includes servo pattern write gaps 126A-C (“pattern gaps 126”). In operation, first servo head 123 receives a generally continuous DC or periodic electrical signal through coil 136, producing a magnetic signal at write gaps 124 to record a servo carrier signal on a servo track of a magnetic tape as the magnetic tape passes relative to heads 123 and 121. Conductive or magnetically permeable shield 122 is positioned between first head 123 and second head 121 in order to eliminate electrical or magnetic interaction between the heads. Second head 121 receives timed electrical pulses through coil 137, producing magnetic fields at pattern gaps 126 as the magnetic tape passes relative to heads 123 and 121. With the magnetic tape moving relative to module 72, the timed pulses of magnetic signals at pattern gaps 126 write the recorded signal to create a plurality of servo frames similar to servo patterns 43 in FIG. 4.

In particular, a direct current electrical signal pulse may be applied to head 121 through coil 137, or alternatively, an alternating signal pulse of substantially different frequency than that applied to head 123 may be applied to head 121 through coil 137. In either case, gaps 124 are arranged to define the servo pattern as described herein. FIG. 6 show a magnetic write head 72 that can magnetically record a time-based servo pattern such as pattern 15 shown in FIG. 1. Other methods may also be used to record the time-based servo pattern optically, capacitively and/or magnetically.

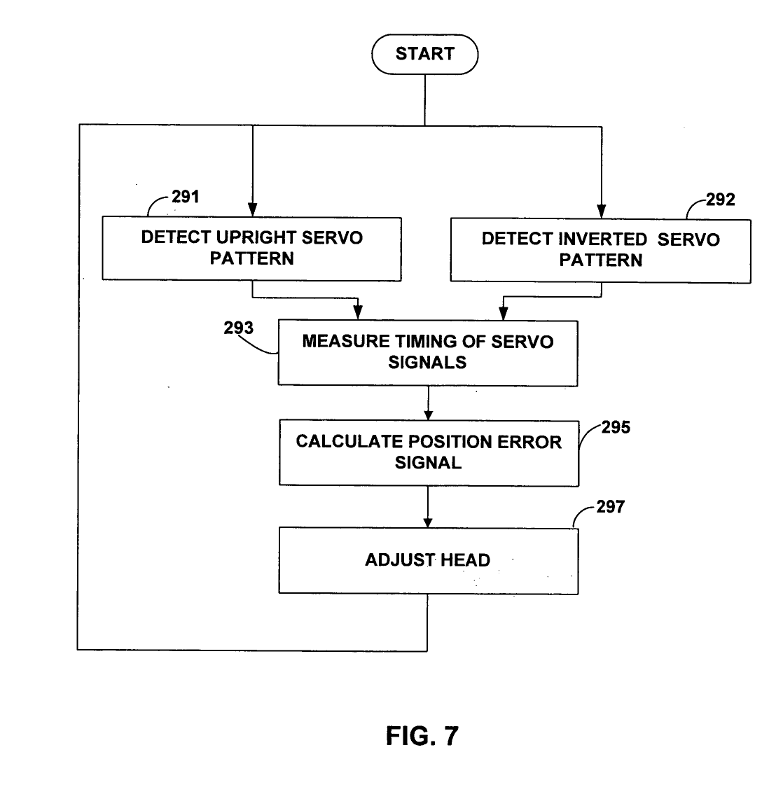

FIG. 7 is a flow diagram illustrating a time-based method for adjusting a servo head's position according to an embodiment of the invention. As shown, servo read heads detect servo signals in an upright pattern (291) and at least one substantially inverted copy of the upright pattern (292). Optionally, the upright servo pattern may be coincident with the substantially inverted servo pattern. Next, a servo controller measures times between servo marks on the servo patterns (293). Then, the servo controller calculates a PES based on the measured times (295). The PES calculation combines times measured from both an upright pattern and a coincident substantially inverted copy of the upright pattern. In this manner, the servo controller can precisely account for media velocity and cancel out error in the PES calculation due to high frequency fluctuations in media velocity. An actuator may adjust the servo head and one or more data heads based on the PES from the servo controller (297). The procedure of FIG. 7 may be repeated in closed-loop fashion, to maintain precise positioning of the servo read heads and one or more data recording/reading heads.

Various embodiments of the invention have been described. Nevertheless, various modifications may be made without departing from the scope of the invention. For example, the techniques described above may be adapted, for example, to magnetic tape that incorporates optically-detectable servo patterns. Although the techniques above have been described in reference to servo patterns 15, 43 and 44, the invention is not limited to servo patterns 15, 43 and 44. Servo patterns 15, 43 and 44 may be modified in many ways. For example, servo line set 18 may be angled in a different direction, or may be curved instead of straight. Additionally, the format on a single medium may include more than one kind of time-based servo pattern.

Furthermore, magnetic tape 40 is merely an exemplary configuration. Embodiments of the invention may contain more or less servo tracks, e.g., two servo tracks, five servo tracks, or even fifteen or more servo tracks. Other embodiments of the invention may contain no servo tracks. For example, in such embodiments, servo patterns 43 and 44 may be contained within dedicated sectors of one or more data tracks. In such cases, the invention may be directed to a linear data recording medium comprising a first data track extending along a length of the medium, a second data track extending along the length of the medium, a first time-based servo pattern within the first data track, wherein the first time-based servo pattern includes a first servo mark, a second servo mark, wherein the second servo mark may be parallel to the first servo mark, and a third servo mark, wherein the third servo mark is non-parallel to the first and second servo marks, and a second time-based servo pattern within the second data track, wherein the second time-based servo pattern comprises a substantially inverted copy of the first time-based servo pattern, wherein a copy of the first servo mark, a copy of the second servo mark and a copy of the third servo mark included in the second time-based servo pattern are substantially inverted with respect to the length of the medium as compared to the first, second and third servo marks.

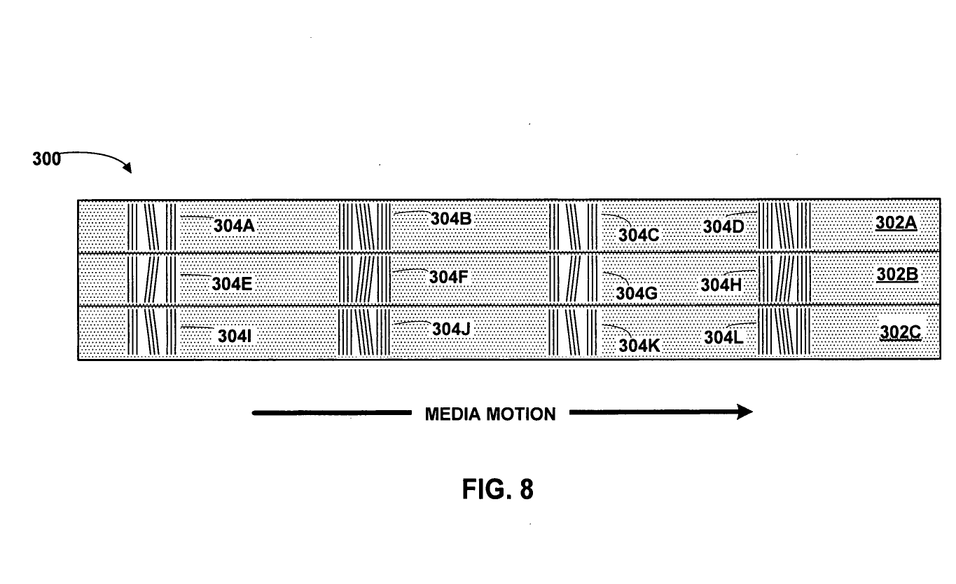

FIG. 8 is an illustration of linear data storage media 300 including repeating N-shaped servo patterns 304A-304L (“servo patterns 304”) embedded within data tracks 302A-302C (“data tracks 302”) of linear storage media 300. Data tracks 304 each extend the length of linear data storage media 300. Unlike magnetic tape 40, linear storage media 302 does not include any servo tracks. Instead, servo patterns 304 are contained within data tracks 302. Because servo patterns 304 are contained within data tracks 302, a read/write head for data tracks 302 also functions as a servo read head. Servo positioning techniques are otherwise similar for linear storage media 302 as for media with separate servo tracks.

For example, servo patterns 304 provide PES information to read heads. A head reading data from one or more of data tracks 302 will also detect servo patterns 304 within those data tracks. Using the coincident pair of servo patterns 304, PES calculations can be performed that reduce error caused by high-frequency fluctuations in tape velocity. To achieve this result, the coincident pair must include one servo pattern 304 from data track 302B as servo patterns 304E-304H in data track 302B are substantially inverted as compared to servo patterns 304A-304D in data track 302A and 304I-304L in data track 302C. The patterns may be read simultaneously by two different heads. The substantially inverted patterns are illustrated as being located on adjacent data tracks, but this is not necessary. In other cases, two different simultaneously read data tracks may include substantially inverted patterns, yet be non-adjacent, e.g., with other data tracks between the data tracks with the substantially inverted patterns.

Each of servo patterns 304 includes a first servo mark, a second servo mark substantially parallel to the first servo mark, and a third servo mark, wherein the third servo mark is non-parallel to the first and second servo marks. As shown in FIG. 8, each of servo patterns 304 actually includes a set of servo marks corresponding to the first servo mark, a set of servo marks corresponding to the second servo mark, and a set of servo marks corresponding to the third servo mark. For example, servo pattern 304A includes three sets of servo marks, each having three servo marks, for a total of nine servo marks. In contrast, servo pattern 304B includes three sets of servo marks, each having four servo marks, for a total of twelve servo marks.

Servo tracks 302 each include servo patterns with a different number of servo marks than at least one other servo pattern in the servo track. For example, servo track 302B includes servo patterns 304E and 304G, each having nine servo marks and servo patterns 304F and 304H, each having twelve servo marks. Varying the number of servo marks included in servo patterns of a servo track may be useful to encode information. For example, it may be useful to encode linear position information.

Servo patterns 304E-304H in data track 302B comprise substantially inverted copies of servo patterns 304A-304D in data track 302A and 304I-304L in data track 302C. Servo marks in each of servo patterns 304E-304H are copies of coincident servo marks in servo patterns 304A-304D and 304I-304L, except the servo marks of servo patterns 304E-304H are substantially inverted with respect to the length of the media as compared servo marks in servo patterns 304A-304D and 304I-304L.

Because a single servo pattern 304 may provide a PES, the distance between servo patterns 304 does not have to be consistent or even be known to a read head. For the same reason, servo patterns 304 may be dispersed throughout data tracks 302, rather than contained with a dedicated servo track. However, to achieve a high error-cancellation effect for high frequency tape velocity fluctuations, each of servo patterns 304 should be a coincident and substantially inverted copy of at least one other of servo patterns 304. For example, servo pattern 304G is a coincident and substantially inverted copy of both of servo patterns 304C and 304K. In this manner servo patterns 304 provide PES throughout media 300. In other embodiments, there may be one or more data tracks which do not include any of servo patterns 304.

The invention is not limited to magnetic tape, but may be useful for any digital storage media making use of servo patterns, including magnetic disks, optical tape, optical disks, holographic disks or cards, and the like. In some embodiments, a servo pattern and a substantially inverted servo pattern coincident with the servo pattern may be adjacent, rather than separated by a data track as shown in FIG. 2. Also, in some embodiments, a substantially inverted servo pattern may not be coincident with a corresponding upright servo pattern. These and other embodiments are within the scope of the following claims.

1. A linear data recording medium comprising:
a first servo track extending along the length of the medium;
a second servo track extending along the length of the medium;
a first time-based servo pattern within the first servo track, wherein the first time-based servo pattern includes a first servo mark, a second servo mark, and a third servo mark, wherein the third servo mark is non-parallel to the first and second servo marks; and
a second time-based servo pattern within the second servo track, wherein the second time-based servo pattern comprises a substantially inverted copy of the first time-based servo pattern, wherein a copy of the first servo mark, a copy of the second servo mark and a copy of the third servo mark included in the second time-based servo pattern are substantially inverted with respect to the length of the medium as compared to the first, second and third servo marks.

2. The medium of claim 1, wherein the first servo pattern is coincident with the second servo pattern.

3. The medium of claim 1, wherein the second servo mark is substantially parallel to the first servo mark.

4. The medium of claim 1, further comprising:
repeating servo patterns in the first servo track, wherein each servo pattern in the first servo track includes at least one copy of the first servo mark, at least one copy of the second servo mark, and at least one copy of the third servo mark; and
repeating servo patterns in the second servo track, wherein each servo pattern in the first servo track includes at least one substantially inverted copy of the first servo mark, at least one substantially inverted copy of the second servo mark, and at least one substantially inverted copy of the third servo mark.

5. The medium of claim 4, wherein the repeating servo patterns in the first servo track are coincident with the repeating servo patterns in the second servo track.

6. The medium of claim 5, wherein the first servo pattern in the first servo track consists of a different number of servo marks than at least one other servo pattern of the repeating servo patterns in the first servo track.

7. The medium of claim 5, wherein each servo pattern of the repeating servo patterns in the second servo track consists of the same number of servo marks as the coincident servo pattern of the repeating servo patterns in the first servo track.

8. The medium of claim 6, wherein the number of servo marks in one or more servo patterns represents linear position information.

9. The medium of claim 1, wherein the first servo pattern comprises:
a first set of servo marks including the first servo mark and one or more additional servo marks, wherein the servo marks included in the first set of servo marks are substantially parallel and immediately adjacent to one another;
a second set of servo marks including the second servo mark and one or more additional servo marks, wherein the servo marks included in the second set of servo marks are substantially parallel and immediately adjacent to one another; and
a third set of servo marks including the third servo mark and one or more additional servo marks, wherein the servo marks included in the third set of servo marks are substantially parallel and immediately adjacent to one another.

10. The medium of claim 9, wherein the second servo pattern comprises:
a copy of the first set of servo marks;
a copy of the second set of servo marks; and
a copy of the third set of servo marks, wherein all servo marks of the second servo pattern are substantially inverted with respect to the length of the medium as compared to the servo marks of the first servo pattern.

11. The medium of claim 1, wherein the third servo mark is between the first servo mark and the second servo mark.

12. The medium of claim 1, wherein the first, second and third servo marks are substantially straight.

13. The medium of claim 1, wherein the medium is a magnetic tape.

14. A method comprising:
sensing a first time-based servo pattern on a recording medium moving in a first direction with a first head of a servo read module, wherein the first time-based servo pattern includes a first servo mark, a second servo mark, and a third servo mark, wherein the third servo mark is non-parallel to the first and second servo marks;
sensing a second time-based servo pattern on the recording medium with a second head of the servo read module, wherein the second time-based servo pattern comprises a substantially inverted copy of the first time-based servo pattern, wherein a copy of the first servo mark, a copy of the second servo mark and a copy of the third servo mark included in the second time-based servo pattern are substantially inverted with respect to the first direction as compared to the first, second and third servo marks;
calculating a position error signal as a function of the sensed time-based servo patterns; and
adjusting positioning of the servo write or read module based on the calculated position error signal.

15. The method of claim 14, further comprising reading from a data track on the recording medium.

16. The method of claim 14, further comprising adjusting positioning of a data read head based on the calculated position error signal.

17. The method of claim 14, wherein calculating a position error signal as a function of the sensed time-based servo patterns comprises:
measuring times between detected servo marks in the first servo pattern to produce a first set of time measurements;
measuring times between detected servo marks in the second servo pattern to produce a second set of time measurements;
using both the first and second sets of time measurements to calculate the position error signal in order to reduce error in the position error signal caused by high frequency fluctuations in velocity of the recording medium.

18. The medium of claim 14, wherein the second servo mark is substantially parallel to the first servo mark.

19. A head for recording a time-based servo pattern comprising:
a first set of servo write gaps that correspond to a first servo frame to be recorded in a first servo track including a first gap, a second gap, and a third gap, wherein the third gap is non-parallel to the first and second gaps; and
a second set of servo write gaps that correspond to a second servo frame to be recorded in a second servo track, wherein the second set of servo write gaps includes a substantially inverted copy of the first set of servo write gaps, wherein a copy of the first gap, a copy of the second gap and a copy of the third gap included in the second set of servo write gaps are inverted with respect to the length of the servo tracks as compared to the first, second and third gaps.

20. A linear data recording medium comprising:
a first data track extending along a length of the medium;
a second data track extending along the length of the medium;
a first time-based servo pattern within the first data track, wherein the first time-based servo pattern includes a first servo mark, a second servo mark, and a third servo mark, wherein the third servo mark is non-parallel to the first and second servo marks; and
a second time-based servo pattern within the second data track, wherein the second time-based servo pattern comprises an inverted copy of the first time-based servo pattern, wherein a copy of the first servo mark, a copy of the second servo mark and a copy of the third servo mark included in the second time-based servo pattern are inverted with respect to the length of the medium as compared to the first, second and third servo marks.
